(19) United States
(12) Patent Application Publication
(10) Pub. No.: US 2013/0334455 A1
(43) Pub. Date: Dec. 19, 2013

(54) Magneto-Dielectric Polymer Nanocomposites and Method of Making

(71) Applicant: University of South Florida, (US)

(72) Inventors: Thomas Weller, Lutz, FL (US); Jing Wang, Tampa, FL (US); Hariharan Srikanth, Tampa, FL (US); Cesar A. Morales-Silva, Tampa, FL (US); Kristen Stojak, Tampa, FL (US); Susmita Pal, Tampa, FL (US)

(73) Assignee: UNIVERSITY OF SOUTH FLORIDA, Tampa, FL (US)

(21) Appl. No.: 13/686,447

(22) Filed: Nov. 27, 2012

Related U.S. Application Data
(63) Continuation of application No. PCT/US2011/038366, filed on May 27, 2011.
(60) Provisional application No. 61/349,053, filed on May 27, 2010.

(51) Int. Cl. H01F 1/00

(52) U.S. Cl. CPC H01F 1/0018
USPC 252/62.54

(57) ABSTRACT

In accordance with the present invention, novel superparamagnetic magneto-dielectric polymer nanocomposites are synthesized using a novel process. The tunability of the dielectric/magnetic properties demonstrated by this novel polymer nanocomposite, when an external DC magnetic field is applied, exceeds what has been previously reported for magneto-dielectric polymer nanocomposite materials.

### CROSS-REFERENCE TO RELATED APPLICATIONS

This application is a continuation of and claims priority to International Patent Application No. PCT/US2011/38366 which was filed on May 27, 2011 which claims priority to U.S. Provisional Patent Application No. 61/349,053, filed on May 27, 2010 which is hereby incorporated by reference into this disclosure.

### STATEMENT OF GOVERNMENT INTEREST

This invention was made with Government support under Grant No. CMMI #0728073 awarded by the National Science Foundation. The Government has certain rights in the invention.

### BACKGROUND

A wide variety of engineered materials have been developed that exhibit advanced magneto-dielectric properties. Such materials can significantly extend the range of microwave characteristics found in common substrates, thus improving the performance of microwave components. In particular, ferrites, ferroelectrics and multiferroics have been widely studied as functional materials with enhanced microwave properties while enabling tunable microwave devices. In addition, polymer nanocomposites with unique absorption properties have been identified as an effective functional material for microwave electromagnetic interference (EMI) shielding. Emerging types of metamaterials show promising magneto-dielectric properties. These materials often involve the inclusion of multiple layers and/or periodic resonant arrays in order to produce tailored microwave properties, although typically within a relatively small bandwidth. Magneto-dielectrics have been shown to enable considerable improvements in the bandwidth and/or size reduction of microwave antennas. However, the works do not simultaneously satisfy many crucial requirements for microwave device applications such as low dielectric and magnetic losses, low power consumption, low biasing electric or magnetic fields, structural simplicity and ease of integration with existing fabrication processes.

One of the promising ways to develop materials showing magneto-dielectric properties is to exploit polymer composites reinforced with magnetic nanoparticles. However, the dispersion of nanoparticles into a polymer matrix has been a challenging task for nanocomposite fabrication. Since the polymer matrix and inorganic nanoparticles often possess different polarities, a simple blending of particles and polymer will result in aggregation of particles. In fabrication of magneto-dielectric materials, the key challenge is the formation of morphologically controlled and highly ordered arrays of nanoparticles over an extended area.

Due to the challenges in the development of these magneto-dielectric materials, there has been very little progress in exploring their potential for tunable microwave applications. There is still a need for improvement with respect to keeping the enhanced magneto-dielectric properties in a wider frequency range, lowering fabrication complexity and reducing size and cost. As a result, extensive utilization of polymer nanocomposites has yet to occur.

Accordingly, there is a need in the art for a low-loss microwave material that exhibits wide tunability of its effective dielectric and magnetic properties.

### SUMMARY OF INVENTION

The invention is a new superparamagnetic Magneto-Dielectric Polymer Nanocomposite (MDPNC), with uniformly dispersed magnetic nanoparticles that has resulted in a new class of low-loss microwave substrates with very large tunability of the dielectric and magnetic properties. The substrate losses were retained at a negligible level due to the mono-dispersion of the sub-10 nm magnetic nanoparticles with zero coercivity and zero remanence, thus leading to low hysteresis losses. These properties provide the potential for advanced performance in many microwave and high-speed devices, including the capability to vary the operating characteristics of the devices (e.g. the operational frequency) in real-time.

In a particular embodiment, a superparamagnetic low-loss polymer nanocomposite is provided comprising magnetic nanoparticles coated with a surfactant and substantially uniformly dispersed in a low-loss polymer. In a particular embodiment, the magnetic nanoparticles are Fe₃O₄ nanoparticles having an average diameter of 8 nm. In an additional embodiment, the magnetic nanoparticles are CoFe₂O₄ nanoparticles having an average size of 10 nm. Other magnetic nanoparticles are within the scope of the present invention. The surfactants used in the formation of the superparamagnetic low-loss polymer nanocomposite may include oleylamine and oleic acid. Other surfactants are within the scope of the present invention. In a particular embodiment, the low-loss polymer is about 25% butadiene resin and copolymer dissolved in xylene. Other low-loss polymers are within the scope of the present invention.

The present invention provides a method for preparing a polymer nanocomposite, useful as a superparamagnetic low-loss material. The method includes, coating magnetic nanoparticles with surfactants, dissolving a low-loss polymer and the coated magnetic nanoparticles in hexane and magnetically stirring the dissolved low-loss polymer and coated magnetic nanoparticles to obtain a polymer nanocomposite having substantially uniform dispersion. The magnetic nanoparticles may be Fe₃O₄ nanoparticles or CoFe₂O₄ nanoparticles. In addition, other magnetic nanoparticles are within the scope of the present invention. The surfactants used in the formation of the superparamagnetic low-loss polymer nanocomposite may include oleylamine and oleic acid. Other surfactants are within the scope of the present invention. In a particular embodiment, the low-loss polymer is about 25% butadiene resin and copolymer dissolved in xylene. Other low-loss polymers are within the scope of the present invention.

### BRIEF DESCRIPTION OF FIGURES

FIG. 1 illustrates a transmission electron microscopy (TEM) image of Fe₃O₄ nanoparticles (˜8 nm mean size) uniformly dispersed in the polymer in accordance with an embodiment of the present invention. Inset on the upper right corner is an example of particle agglomeration without the usage of surfactants.

FIG. 2 illustrates M-H curves for as-synthesized magnetite (Fe₃O₄) nanoparticles and the MDPNC (at 80% w/w) in accordance with an embodiment of the present invention. Inset on the right side shows the expanded view of the low field region clearly indicating lack of coercivity or remanence in the materials.

FIG. 3 illustrates the 3-dimensional architecture of the multi-layer microstrip structure for extraction of the microwave properties of MDPNCs.

FIG. 4 illustrates the measured transmission parameter of the microstrip linear resonator (MLR) with MDPNC prepared in accordance with the present invention. Loaded Q-factor, transmitted power and resonance frequency are dependent of the applied magnetic biasing field.

FIG. 5 Measured Q-factor and resonant frequency vs. DC magnetic field strength. Q-factor, transmitted power and resonance frequency are dependent of the applied magnetic biasing field.

FIG. 6 illustrates the extracted magnitude of ∈ᵣ, for Fe₃O₄ polymer nanocomposite (at 80% w/w) in accordance with the present invention.

FIG. 7 illustrates the extracted magnitude of μᵣ, for Fe₃O₄ polymer nanocomposites (at 80% w/w) in accordance with the present invention.

FIG. 8A illustrates the extracted tan δ, for Fe₃O₄ polymer nanocomposites (at 80% w/w) at frequencies of 1 GHz, 2 GHz and 3 GHz, in accordance with the present invention.

FIG. 8B illustrates the extracted tan δ, for Fe₃O₄ polymer nanocomposites (at 80% w/w) at frequencies of 4 GHz, 5 GHz and 6 GHz, in accordance with the present invention.

FIG. 9A illustrates a comparison of the attenuation calculated directly from S-parameters and that calculated using the extracted parameters at frequencies of 1 GHz, 2 GHz and 3 GHz, in accordance with the present invention.

FIG. 9B illustrates a comparison of the attenuation calculated directly from S-parameters and that calculated using the extracted parameters at frequencies of 4 GHz, 5 GHz and 6 GHz, in accordance with the present invention.

FIG. 10A illustrates an XRD pattern of 10 nm CoFe₂O₄ in accordance with the present invention.

FIG. 10B illustrates a TEM image of 10 nm CoFe₂O₄ nanoparticles (NPs) in accordance with the present invention.

FIG. 11A illustrates a high resolution TEM micrograph of 30 wt % CoFe₂O₄-thermoset low loss polymer composite in accordance with the present invention.

FIG. 11B illustrates a high resolution TEM micrograph of 50 wt % CoFe₂O₄-thermoset low loss polymer composite in accordance with the present invention.

FIG. 11C illustrates a high resolution TEM micrograph of 80 wt % CoFe₂O₄-thermoset low loss polymer composite in accordance with the present invention.

FIG. 11D illustrates a high resolution TEM micrograph of 50 wt % CoFe₂O₄-thermoset low loss polymer composite in accordance with the present invention.

FIG. 12 illustrates M-T plot of 30 wt %, 50 wt %, 80 wt % CoFe₂O₄-thermoset low loss polymer composite nanocomposites and pure CoFe₂O₄NPs.

FIG. 13A illustrates M-H plots of 30 wt %, 50 wt %, 80 wt % CoFe₂O₄-thermoset low loss polymer composite nanocomposites and pure CoFe₂O₄NPs at 300K.

FIG. 13B illustrates M-H plots of 30 wt %, 50 wt %, 80 wt % CoFe₂O₄-thermoset low loss polymer composite nanocomposites and pure CoFe₂O₄NPs at 10K.

FIG. 14 is a table illustrating blocking temperatures.

FIG. 15 is a cross-sectional diagram illustrating the multilayer microstrip linear resonator.

FIG. 16 illustrates the measured transmission characteristics of the microstrip linear resonator with embedded cobalt ferrite nanocomposite with 80 wt % loading. The transmitted power and resonance frequency show a strong dependence on the strength of the applied DC magnetic field.

FIG. 17A illustrates the measured quality factor and resonant frequency versus DC magnetic field strength for microstrip resonator devices with 80 wt % loading of CoFe₂O₄NPs.

FIG. 17B illustrates the measured quality factor and resonant frequency versus DC magnetic field strength for microstrip resonator devices with 50 wt % loading of CoFe₂O₄NPs.

FIG. 17C illustrates the measured quality factor and resonant frequency versus DC magnetic field strength for microstrip resonator devices with 30 wt % loading of CoFe₂O₄NPs.

### DETAILED DESCRIPTION

In accordance with the present invention, novel superparamagnetic magneto-dielectric polymer nanocomposites are synthesized using a novel process. The tunability of the dielectric/magnetic properties demonstrated by this novel polymer nanocomposite, when an external DC magnetic field is applied, exceeds what has been previously reported for magneto-dielectric polymer nanocomposite materials.

In a particular embodiment, Fe₃O₄ (magnetite) nanoparticles with mean size of 8 nm and coated with surfactants (oleylamine and oleic acid) were synthesized following a standard chemical co-precipitation procedure. The low-loss polymer was dissolved in hexane along with different amounts of surfactant-coated nanoparticles to obtain the polymer nanocomposites with uniform dispersion of nanoparticles at the desired concentration.

The surfactant plays a dual role in the synthesis of polymer nanocomposites. The surfactant completely encapsulates and isolates individual particles and thus weakens the magnetic exchange interactions between them. Moreover, the choice of surfactant is also important to enhance the binding between the macromolecular chains of the polymer and the individual nanoparticles; this binding prevents the particle diffusion during the formation of the polymer nanocomposite, thus effectively suppressing the tendency of agglomeration. This chemical process is important because the goal is to retain the superparamagnetic properties of both individual magnetic nanoparticles and entire macroscopic magneto-dielectric polymer nanocomposite (MDPNC) material, even at relatively high packing densities. Superparamagnetism or lack of coercivity, which implies no hysteresis losses, is desirable for low-loss microwave magnetic materials. Thus the polymer nanocomposites in accordance with the present invention are well-suited for implementation of numerous tunable and low-loss RF and microwave devices.

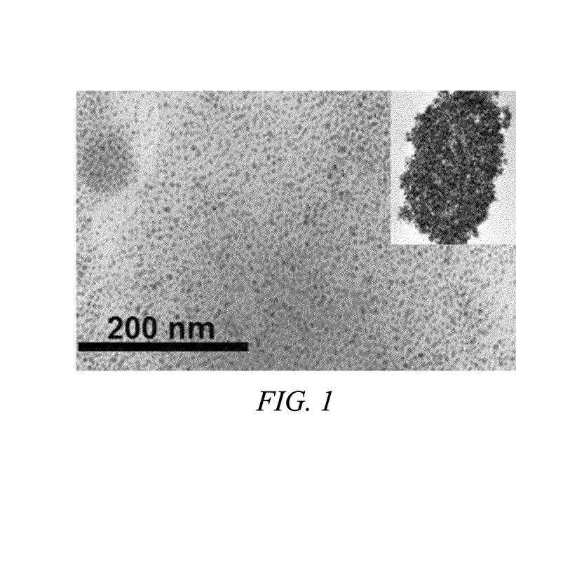

FIG. 1 presents a typical transmission electron microscopy (TEM) image of the chemically synthesized, surfactant coated Fe₃O₄ nanoparticles dispersed in the polymer and spin coated as 20 μm-thick films on glass substrates or microwave calibration boards. As seen in this figure, excellent dispersion is achieved and nanoparticles do not form clusters. The inset on the upper right corner of the same figure shows a classic example of agglomeration if the proper chemical processing with surfactants is not done during the polymer film coating.

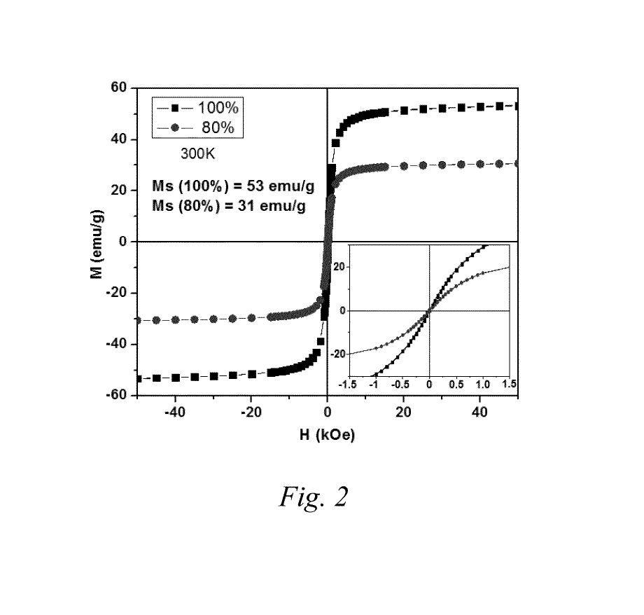

In order to verify that the superparamagnetic response retained in the MDPNC, due to the homogenously dispersed ferrimagnetic nanoparticles in the polymer matrix, magnetization measurements were done by Physical Property Measurement System (PPMS). FIG. 2 presents measured M-H loops for the Fe₃O₄ nanoparticles and the MDPNC at 80% v/v. The data show excellent saturation magnetization characteristics and zero coercivity as well as zero remanence, at room temperature, which are the characteristic signatures of superparamagnetism.

To evaluate the tunability of the MDPNC in accordance with the present invention, a multi-layer microstrip linear resonator (MLR) filled with polymer nanocomposites was designed to study the variation of the MDPNC's microwave properties. The resonance frequency of the microstrip resonator depends on the effective material properties of the substrate given by:

$$\begin{matrix}{f}_{r} = \frac{{v}_{p}}{{λ}_{g}} = \frac{c}{{λ}_{g} \sqrt{{ɛ}_{eff} \times {μ}_{eff}}} \\ and & ( 1 ) \\ {λ}_{g} = \frac{2 {l}_{r}}{n} & ( 2 )\end{matrix}$$

where lᵣ is the length of the center conductor in the MLR and n represents the n^{th} resonant frequency of the MLR. The characteristic impedance of the microstrip feed lines was designed to be 50Ω.

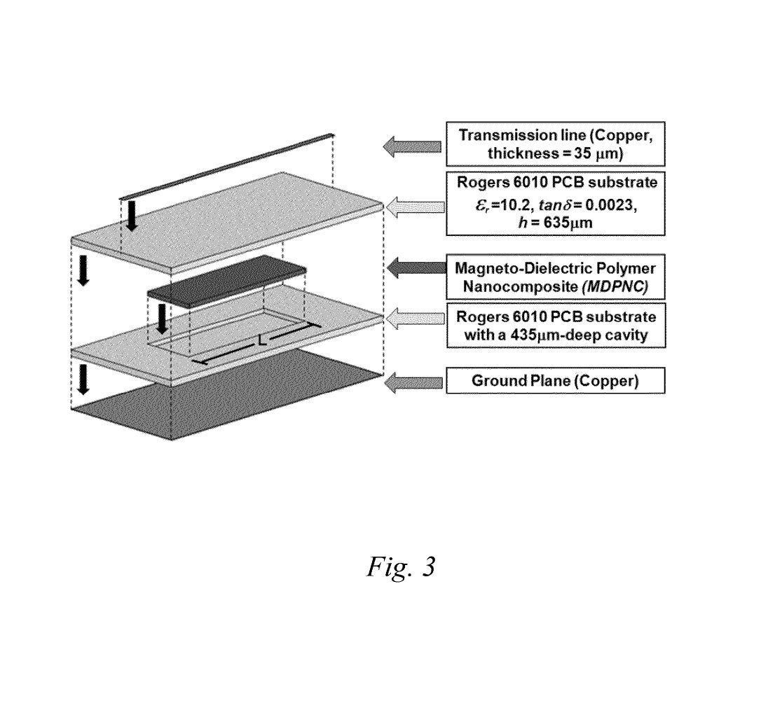

The MLR test fixture is formed by bonding two printed circuit board (PCB) laminates together. The RF PCB laminate chosen was a thermoset low loss polymer composite (∈ᵣ=10.2, tan δ=0.0023) with a thickness of 635 μm, which offers a high dielectric constant and thus good contrast with the MDPNC material. The MDPNC is deposited in the 435 μm cavity (bottom laminate), and heated in a vacuum oven at 90° C. for 4 hours to harden (cure) the composite materials. FIG. 3 presents the 3-dimensional architecture of the test structure.

Two-port S-parameters measurements were performed and concurrently, an external magnetic field in the range from 0 to 4 kOe is applied to the MLR. The orientation of the magnetic field lies perpendicular to the direction of signal propagation. The base material was composed of ferromagnetic nanowires under magnetic fields up to 9 kOe to modulate the response of such device. In the case of the MDPNC in accordance with the present invention, a maximum magnetic field of 4 kOe was needed to obtain the peak performance due to the superparamagnetic nature of the material. This field can be easily obtained using small and low-cost commercial Neodymium magnets.

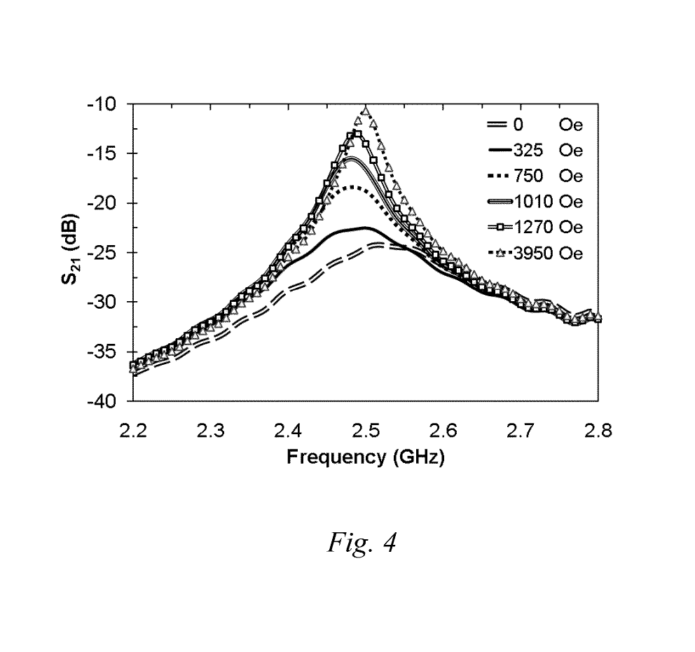

FIG. 4 presents the measured transmission characteristic S₂₁ of the MLR versus applied DC magnetic field. As shown, a resonance frequency of 2.537 GHz along with an insertion loss of 24.2 dB and a measured loaded Q of 13 is observed in the absence of magnetic field. As the strength of externally applied DC magnetic field is increased, change in the resonance frequency is measured. Concurrently, the insertion loss decreases and the Q of the resonator increases. The MDPNC exhibits a different behavior compared with other traditional ferrite materials used for microwave applications. In the prior art, as the strength of the applied DC magnetic field increases, the insertion loss increases along with a drop of the Q factor.

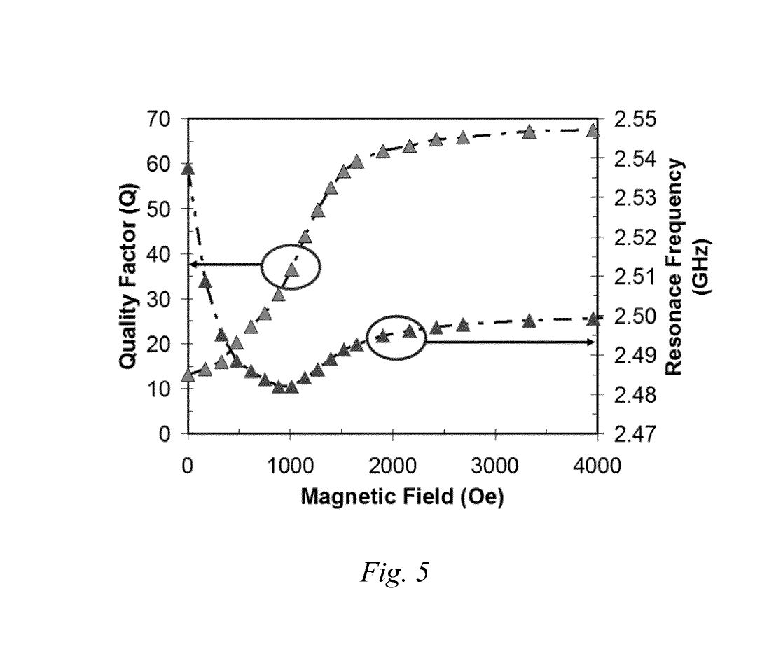

The influence of the DC magnetic field on the resonance frequency of the device is shown in FIG. 5. A deviation of 57 MHz in the resonance frequency was observed (from 2.537 GHz to 2.480 GHz) as the field varied from 0 to 4 kOe. Also, under an external field of 4 kOe, the maximum loaded Q factor of 67 is demonstrated along with the lowest insertion loss of 10.5 dB.

A non-resonant multi-layer microstrip transmission line was employed to extract the microwave properties of the MDPNC (e.g., ∈ᵣ, μᵣ and tan δ). The structure of this device is similar to the multi-layer MRL. The key difference is that the through transmission line between the two ports is uninterrupted.

Microwave properties of the material were extracted using an improved technique derived from the Nicolson-Ross-Weir method, and a conformal mapping method was used to extract analytical relations for the filling factor of the multi-layer structure.

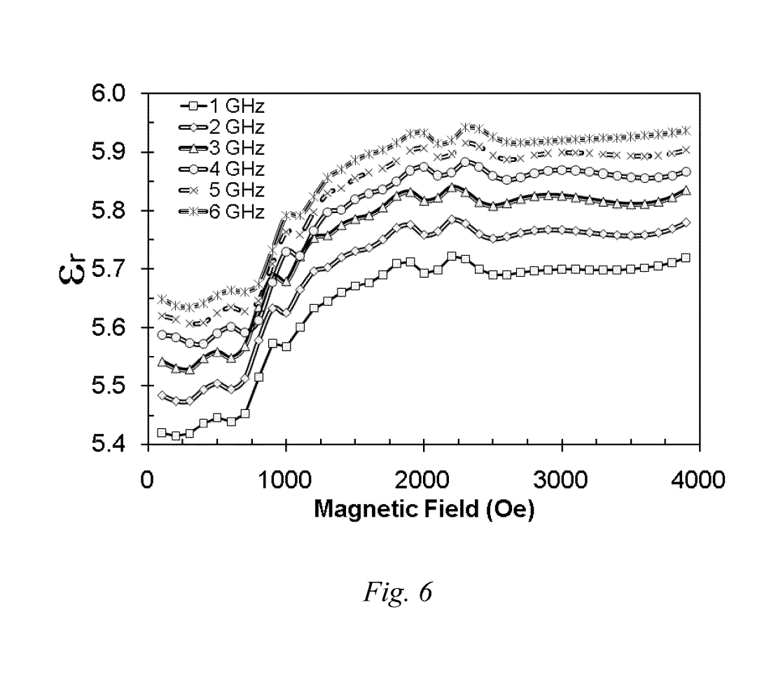

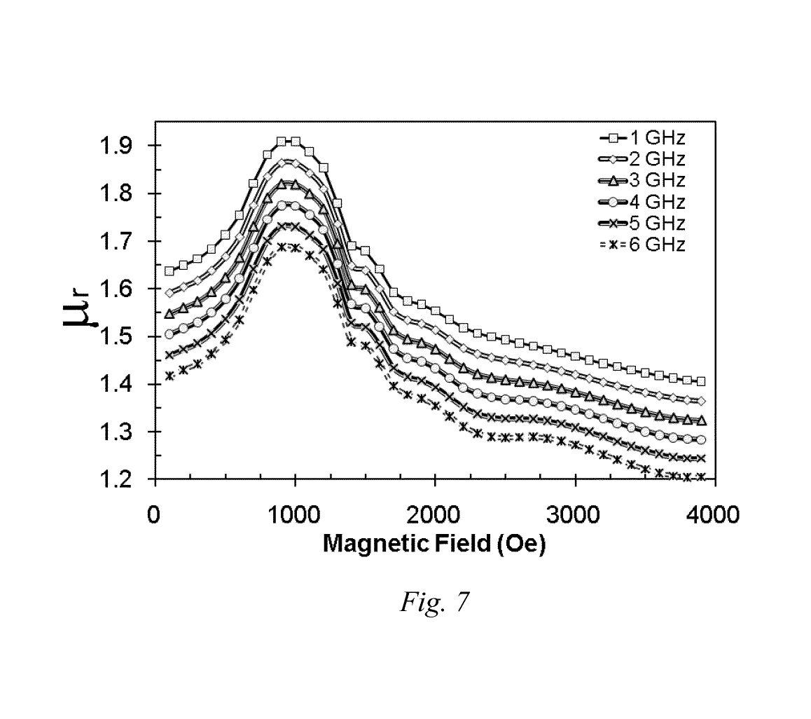

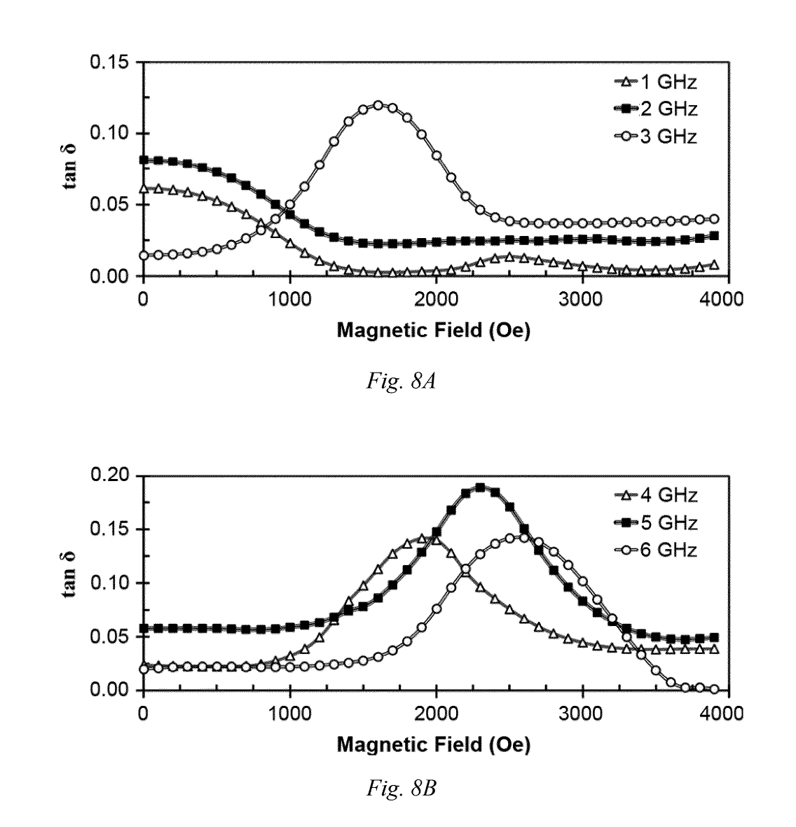

∈ᵣ, μᵣ and tan δ were extracted from 0.65 to 6 GHz at room temperature conditions (300 K) and plotted vs. the applied magnetic biasing field. FIG. 6, FIG. 7 and FIG. 8A and FIG. 8B present the extracted values for ∈ᵣ, μᵣ and tan δ of the synthesized magneto-dielectric polymer nanocomposites with 80% by volume of 8 nm magnetite (Fe₃O₄) nanoparticles. Note that ∈ᵣ and μᵣ reach saturation points at 2 and 4 kOe, respectively. In addition, μᵣ shows ferromagnetic resonance (FMR) characteristic associated with the presence of (Fe₃O₄) in the MDPNC.

As shown in FIG. 8A and FIG. 8B, the response of the tan δ has a maximum and a minimum of 0.2010 and 0.0011, respectively. This clearly indicates that losses in the material have large susceptibility to external applied magnetic fields.

The accuracy of the parameters extraction procedure has been validated by comparison of the calculated attenuation obtained from the extracted material properties, and the attenuation calculated from the S-parameter measurements. From the extracted parameters:

$$\begin{matrix}tan δ = \frac{{δ}_{r}^{″}}{{δ}_{r}^{′}} \\ where & ( 3 ) \\ {δ}_{r}^{′} = {μ}_{r}^{′} {ɛ}_{r}^{′} - {μ}_{r}^{″} {ɛ}_{r}^{″} \\ and & ( 4 ) \\ {δ}_{r}^{″} = {μ}_{r}^{′} {ɛ}_{r}^{″} - {μ}_{r}^{″} {ɛ}_{r}^{′} & ( 5 )\end{matrix}$$

The calculated attenuation from the extracted parameters is expressed as:

$$α = {\frac{π \sqrt{2 {δ}_{r}^{′}}}{{λ}_{0}} [ \sqrt{1 + {tan}^{2} δ} - 1 ]}^{1 / 2} \qquad ( 6 )$$

On the other hand, the measured attenuation is calculated from the S-parameters:

$$\begin{matrix}{e}^{- ( α + j β ) = {\{ \frac{1 - {S}_{11}^{2} + {S}_{21}^{2}}{2 {S}_{21}} \pm K \}}^{- 1}} \\ where & ( 7 ) \\ K = {\{ \frac{{( {S}_{11}^{2} - {S}_{21}^{2} + 1 )}^{2} - {( 2 {S}_{11} )}^{2}}{{( 2 {S}_{21} )}^{2 }} \}}^{1 / 2} & ( 8 )\end{matrix}$$

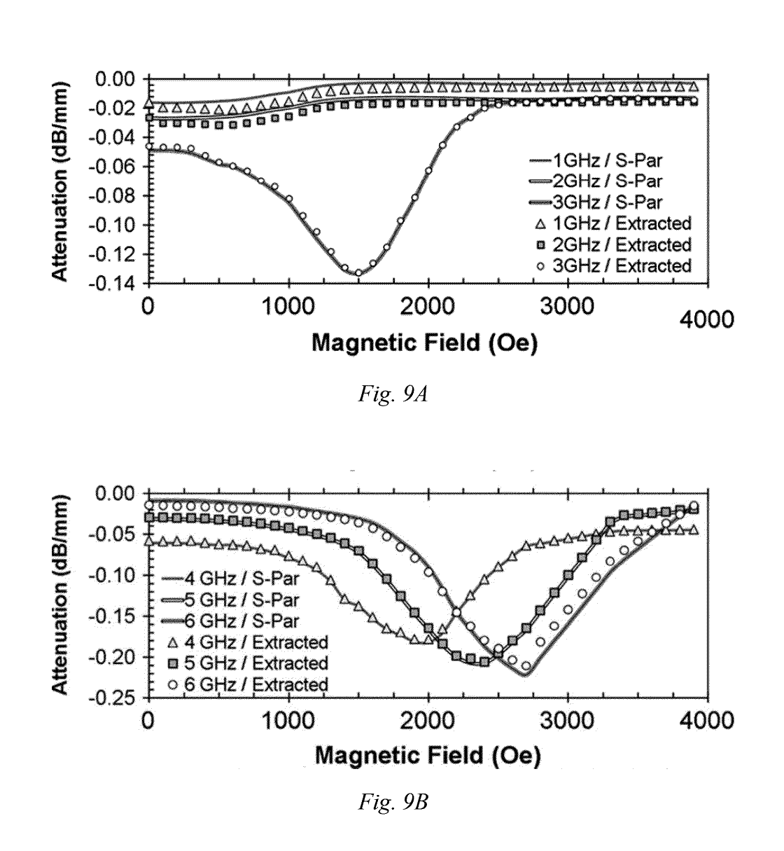

FIG. 9A and FIG. 9B present the comparison of the attenuation calculated directly from the S-parameters and the calculated using the extracted parameters.

The present invention illustrates that magneto-dielectric polymer nanocomposites with 8 nm Fe₃O₄ nanoparticles have great potential to be implemented in the fabrication of low-loss and tunable microwave substrates and devices. An important novelty of such material resides in its superparamagnetic properties that guarantee low loss at microwave frequencies. Implementing a MLR as the carrier of the MDPNC, measured frequency tunability of 57 MHz, and marked enhancement of the quality factor from 13 to 67 (5.1× improvement) were achieved with an externally applied DC magnetic field of less than 4 kOe. The observed variations in the resonance frequency, insertion loss and quality factor of the fabricated device clearly indicate the large sensitivity of the device to magnetic bias fields. Undoubtedly, this nanocomposite material shows fascinating properties that has never been reported and will be applicable in improved microwave device applications.

In an additional embodiment, CoFe₂O₄(CFO), which is a well-known hard magnetic material in its bulk form with large coercivity, exchange bias and high saturation magnetization is used in the fabrication of magneto-dielectric polymer nanocomposite in accordance with present invention.

In a particular embodiment of the present invention the high temperature synthesis for CoFe₂O₄NPs includes taking 2 mmol of a mixture of cobalt (II) acetylacetonate and iron (III) acetylacetonate in 1:2 ratio by weight. Then the mixture was added to 10 mmol 1,2, hexadecanediol, 6 mmol oleic acid, 6 mmol oleylamine, and 20 ml benzyl ether. The mixture was heated to 200° C. for 2 h with constant stirring and then reflexed at 300° C. for 1 hour in the presence of Ar gas. The reaction mixture was allowed to cool to room temperature and ethanol was added to the cooled mixture. The black precipitate was separated by centrifugation. The final product CoFe₂O₄NPs was dispersed in hexane. The resulting NPs were 10±1 nm in size on average and had no obvious indication of agglomeration over several regions of the samples observed, as verified by transmission electro microscope (TEM) images.

The polymer nanoparticle composites (PNCs), consisting of a thermoset low loss polymer composite polymer and CFO, were prepared by adding a calculated amount of CFO to the polymer by weight to get the desired compositions. Nanocomposites with 30, 50 and 80% wt of CFO in the thermoset low loss polymer composite were prepared. Both the polymer and the NPs were dissolved in hexane and magnetically stirred overnight to obtain uniform dispersion.

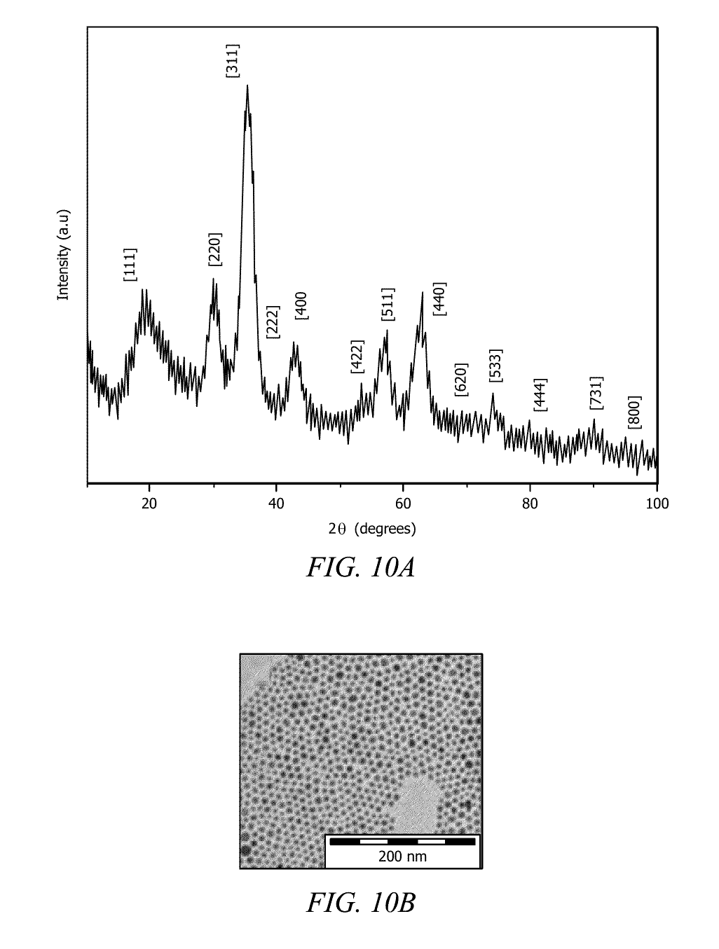

To test the CoFe₂O₄ polymer nanocomposite, the microstrip test fixture previously was utilized. The x-ray diffraction (XRD) patter of CFO NPs is shown with reference to FIG. 10(a). All the peaks in the pattern correspond to the expected inverse cubic spinel structure of CoFe₂O₄. FIG. 10(b) shows the transmission electron microscopy (TEM) image of CFO NPs. As shown, the particles are nearly spherical in shape, with mean particle size 10±1 nm in diameter, and are well separated from each other.

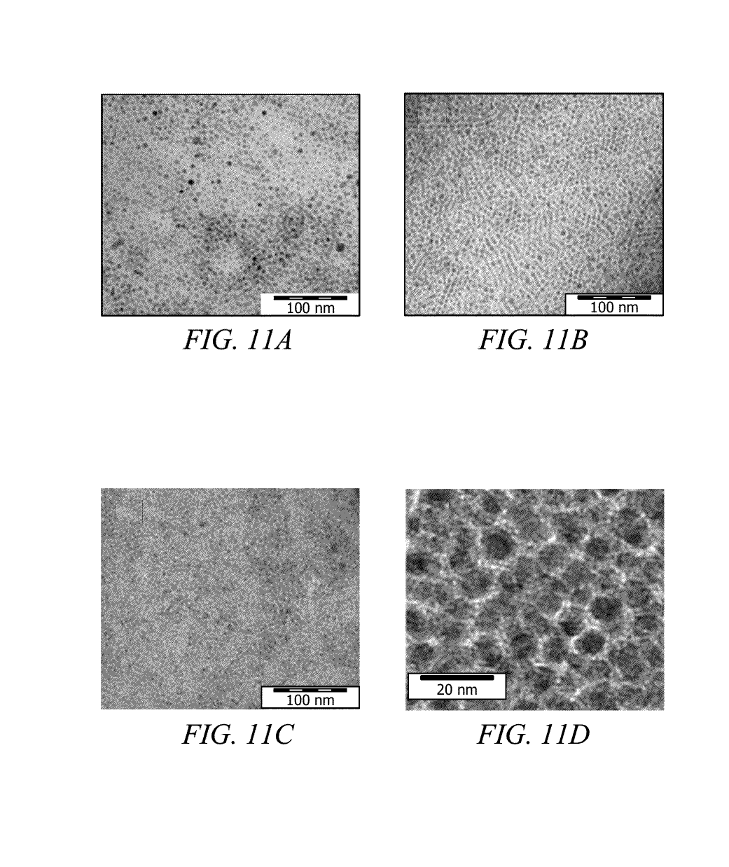

To examine the dispersion of CFO NPs in the polymer matrix, TEM images of the PNCs were taken. TEM images of 30, 50 and 80% wt PNCs are depicted in FIG. 11(a)-11(d). From FIG. 11 it is clearly seen that the particles are evenly dispersed throughout the polymer matrix with no discrete cluster formation even at the highest particle loading (80 wt % CFO) composite. A closer view of the 50 wt % composite (FIG. 11(d)) using high resolution TEM reveals the clear boundaries between particles and the polymer matrix.

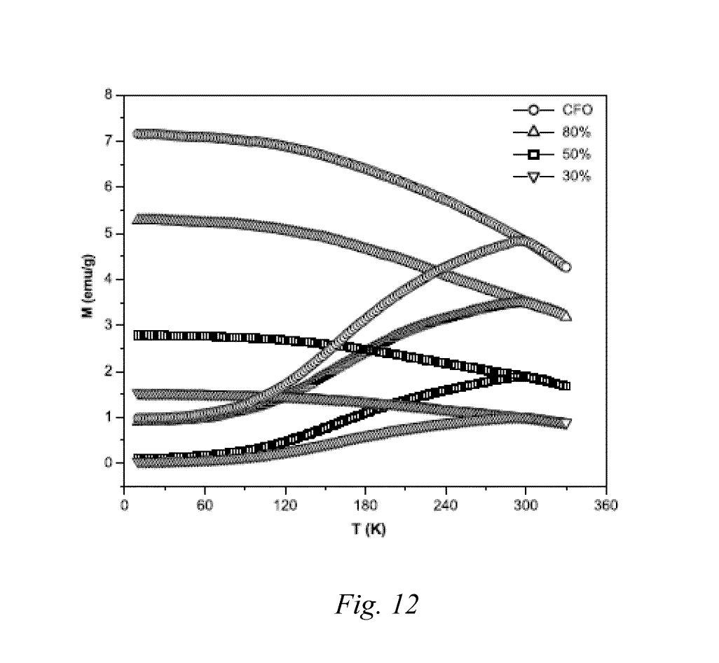

The magnetization (M) measurements were done in the temperature (7) range from 330 degrees K down to 10 degrees K and magnetic fields (H) up to 50 kOe using a commercial physical properties measurement (PPMS). The DC magnetic characterizations were done using field cooled-zero field cooled (FC-ZFC) mode M-T and M-H hysteresis loop measurements in ZFC mode. For this purpose the samples were loaded in a standard gelatin capsule. FIG. 12 shows the temperature dependence of the field cooled (FC) and zero field (ZFC) magnetization of the four different samples of PNCs measured under the applied field of 100 Oe. For all samples the ZFC curve shows a maximum temperature corresponding to the blocking temperature (T_{B}) of the NPs, above which the particles are superparamagnetic, and decreases rapidly at lower temperatures, while the FC curve increases as temperature decreases in the temperature ranged of 330-10 degrees K. The observed magnetization is characteristic of single domain nanoparticles. The blocking temperature of a single domain particle can be described by the relation:

$${T}_{B} = \frac{KV}{25 {k}_{B}} \qquad ( 9 )$$

where K is the magnetocrystalline anisotropy, V is the volume of the nanoparticle and k_{B} is the Boltzmann constant. It can be observed from FIG. 12 that T_{B} is 298 degrees K for CFO and it remains the same for all the thermoset low loss polymer-CFO composites. The advantage of using these CFO NPs is that their blocking temperature (T_{B}=298 degrees K) is around room temperature and thus the superparamagnetic and blocked states could both be effectively used for different applications that require soft magnetic or hard magnetic properties of the dispersed nanoparticles in the PNCs. This may provide interesting results for microwave transmission through waveguides coated with such PNCs. The peak width of the ZFC curve is related to the relaxation time distribution and correspondingly the particle volume distribution, as shown in equation. From the M-T graphs, it is clear that the peak width of the ZFC curve for all the composites look similar, indicating that the effective particle size distribution is not affected by the loading concentrations, which is consistent with the TEM results.

In the present invention, T_{B} remains nearly constant for all PNCs, with the value being exactly same as CFO NPs, which indicates that the interparticle interactions are less prominent here because of a homogeneous dispersion of particles with average size of 10±1 nm in the polymer matrix, as shown in TEM. It also indicates that the surfactant coating of the particles is robust and preserved during the PNC formation. This observation is very important for tunable microwave applications as problems with particle dispersion are known to affect the response and often yield results that are not reproducible from sample to sample.

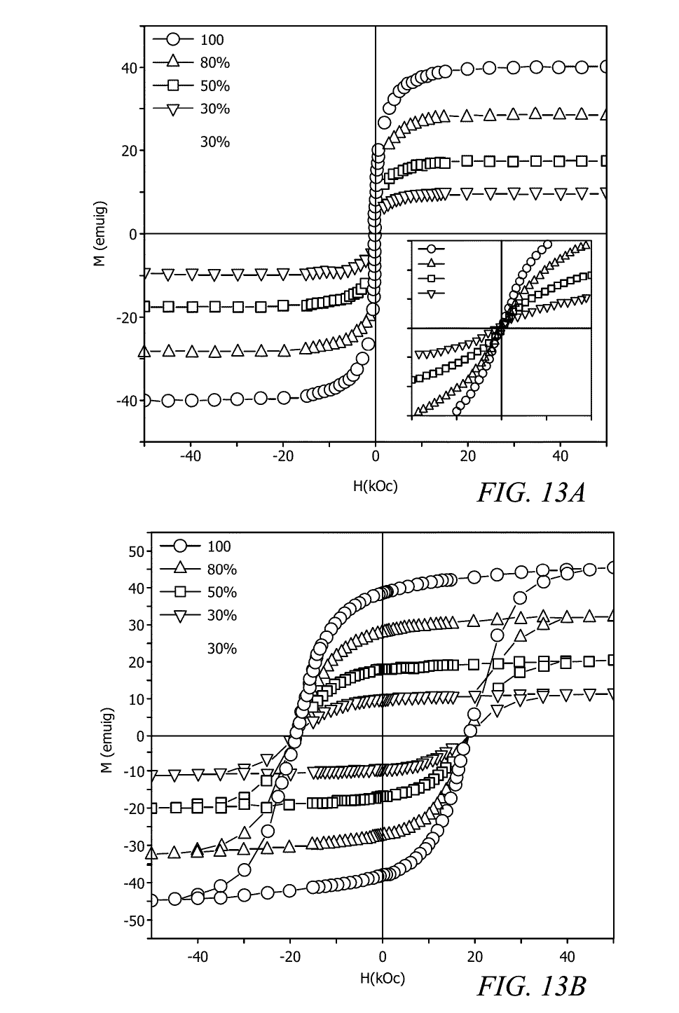

In order to investigate the superparamagnetic nature and magnetization profile of the PNCs, M-H data have been measured at 300 degrees K and 10 degrees K. FIG. 13(a)-13(b) shows the dependence of the magnetization on the field in the range of ±50 kOe at 300 degrees K and at 10 degrees K. The M-H curves at 300 degrees K show no hysteresis (FIG. 13(a) inset), which is consistent with superparamagnetic behavior, whereas M-H curves at 10 degrees K have a hysteresis loop (FIG. 13(b)) with high coercivity (H_{c}=19 kOe).

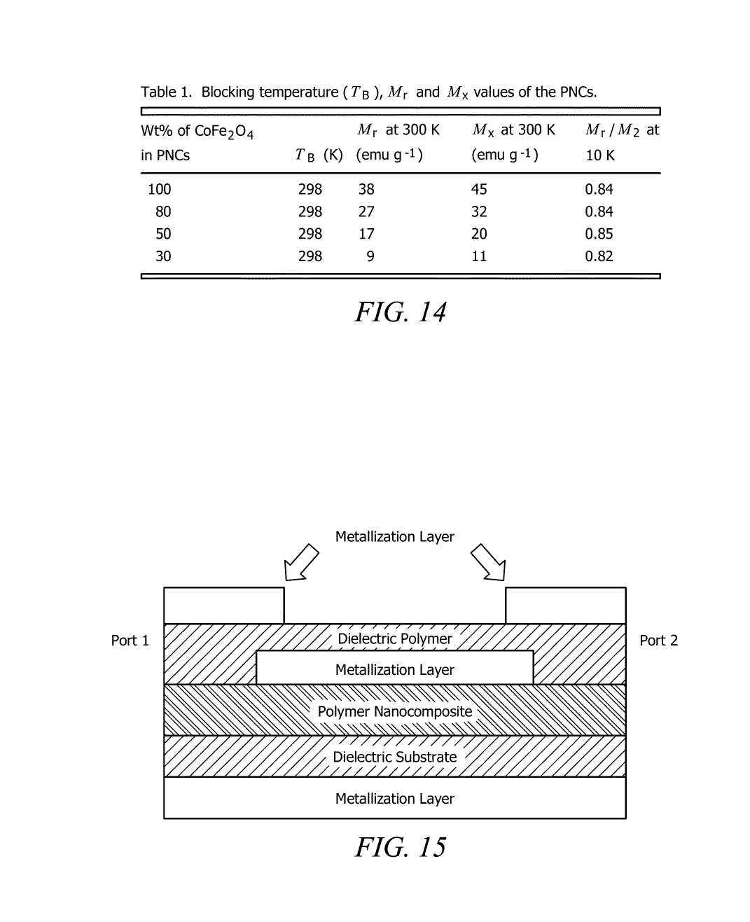

The saturation magnetization (Mₛ) increases with increasing particle loading in the composites, as shown in the table of FIG. 14, which is to be expected with the increase in magnetic volume. It is worth mentioning here that the coercivity of each sample (H_{c}=19 kOe) at 10 degrees K does not change on increasing the percentage loading of the CFO in the system. In the present invention, it has been seen that upon increasing the particle density from 30 to 80 wt % in PNCs, neither T_{B} nor H_{c} change, which is extremely important for tunable device fabrication. The reduced remanence (Mᵣ/Mₛ) from the hysteresis loop at 10 degrees K has been determined for all the samples (Table of FIG. 14). It is seen that this value also does not alter with CFO loading in the samples. It is reported that the reduced remanence can be a measure of inter-particle interactions in single domain particles. The experimental results (Mᵣ/Mₛ˜0.8) are again consistent with a weak inter-particle interaction being present in these PNCs that does not vary with CFO loading concentration.

To test the microwave response of these PNCs, a two-port microstrip linear resonator was designed using the multilayer structure shown schematically in FIG. 15. The resultant frequency of the resonator relies on the effective material properties of the substrate used, following the relation:

$${F}_{r ∝ \frac{1}{\sqrt{μɛ}}} \qquad ( 10 )$$

in which μᵣ and ∈ᵣ are the effective permeability and permittivity, respectively, for the multilayer system.

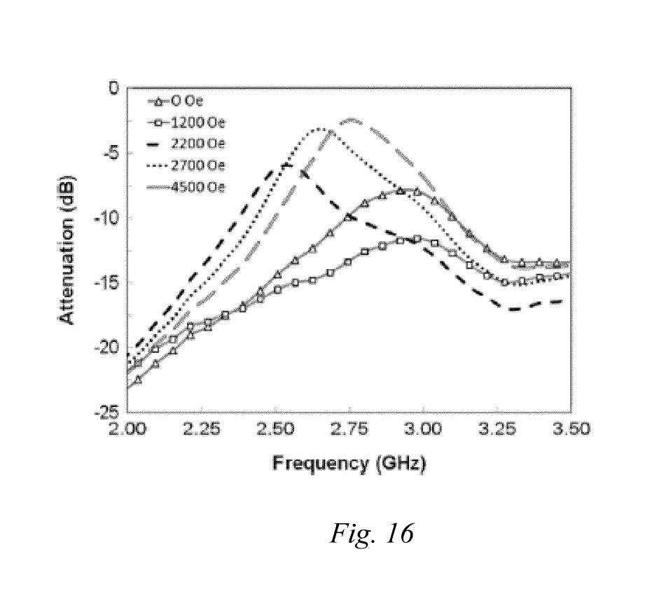

FIG. 16 presents the measured transmission characteristics of the aforementioned resonator with embedded CFO PNCs versus applied DC magnetic field for the sample with 80% loading. The observed variations in the resonance frequency are due to the changes in the permeability and permittivity of the PNC. The changes in the magnitude of the transmission characteristics and quality factor of the device are also partially related to the variation in the effective losses of the nanocomposite material.

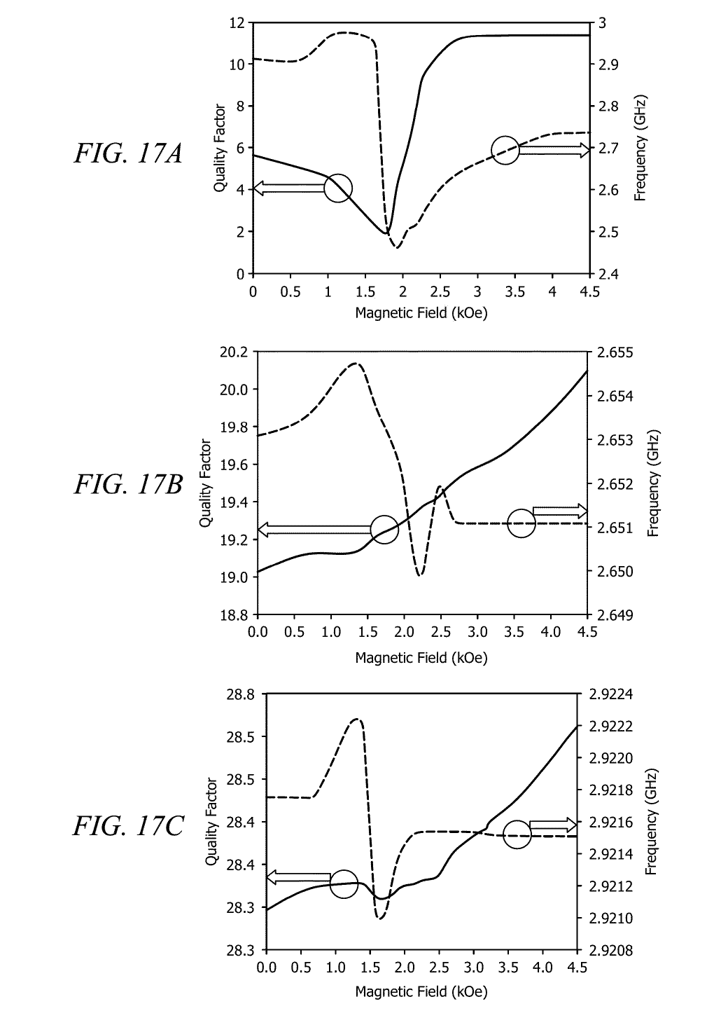

The influences of the DC magnetic field on the resonance frequency and quality factor of the microstrip linear resonators with 80 wt %, 50 wt % and 30 wt % loadings of PNC are shown in FIGS. 17(a), 17(b) and 17(c) respectively. For the device with 80 wt % loading of CFO, a strong deviation of 518 MHz (from 2.976 to 2.458 GHz) in the resonance frequency was observed, which implies that the product of μᵣ and ∈ᵣ experienced a significant variation under the application of an external magnetic field. Furthermore, the quality factor was increased by 5.6× from 2.0 to 11.46 along with the lowest insertion loss of 2.67 dB under an external field of less than 4.5 kOe. It is important to note that the extracted Q-factor for the resonator with the highest CFO loading (80 wt %) is greatly enhanced with increasing magnetic field. Evidently, the incorporation of a high concentration of magnetic nanoparticles into a polymer matrix improves the tunability of the complex permittivity and complex permeability at microwave frequencies.

However, as compared with the 80 wt % sample of PNC, the other samples with reduced loading of 50 and 30 wt % only demonstrate subtle changes in their measured frequency responses under the influence of the externally applied DC magnetic field, as shown in FIGS. 17(b) and 17(c). In particular, a frequency deviation of 5 MHz and much smaller change in Q-factor, from 19.03 to 20.1, were observed for 50 wt % loading, while a frequency deviation of 1.25 MHz and a change in Q-factor, from 28.3 to 28.51, were observed for 30 wt % loading. Clearly, PNC with lower concentrations of magnetic nanoparticles leads to a less tunable material. With respect to the tunability of the CFO nanocomposite material, it is obvious that a fairly high loading beyond 50 wt % would be preferred. However, as the incorporation of the magnetic nanoparticles also introduces noticeably extra losses, a design strategy and trade off might be needed to achieve the best balance between the desired tunability and the microwave performance of the devices.

The present invention illustrates the successfully synthesis of three different thermoset low loss polymer nanocomposites embedded with CoFe₂O₄ nanoparticles and a uniform particle dispersion has been achieved throughout the polymer matrix, as shown in the TEM images. Magnetic measurement data revealed superparamagnetic behavior at room temperature for all the PNCs. The important magnetic parameters, namely blocking temperature, coercivity and reduced remnant magnetization, do not vary with changing loading percentage of the NPs. A strategically designed multilayer microstrip linear resonator embedded with different loadings of PNC was chosen as a test fixture to evaluate the susceptibility of the microwave properties of the PNC under the influence of an externally applied magnetic field. For the device with 80 wt % loading, a measured frequency tunability of 518 MHz, and marked enhancement of the quality factor from 2 to 11.46 (5.6 fold improvement) were achieved with an externally applied DC magnetic field of less than 4.5 kOe. The observed variations in the resonance frequency, insertion loss and quality factor of the fabricated device clearly indicate the high sensitivity of the device to magnetic bias fields. Significant microwave responses are observed for the highest CFO loading nanocomposite. On the contrary, devices with reduced loading of magnetic nanoparticles demonstrated much less severe changes in their measured responses, such as the resonance frequency and quality factor, under the influence of the externally applied DC magnetic field. Clearly, loading of PNC beyond a certain threshold value might be preferred to enable great tunability of the nanocomposite material. However, the incorporation of higher levels of magnetic nanoparticles also slightly compromises the performance of the device by introducing additional losses. A design strategy taking into account all of the performance metrics would provide a guideline to achieve the best tradeoff between tunability and losses for this new class of nanocomposite materials.

What is claimed is:

1. A superparamagnetic low-loss polymer nanocomposite comprising magnetic nanoparticles coated with a surfactant and substantially uniformly dispersed in a low-loss polymer.

2. The superparamagnetic low-loss polymer nanocomposite of claim 1, wherein the magnetic nanoparticles are Fe₃O₄ nanoparticles.

3. The superparamagnetic low-loss polymer nanocomposite of claim 2, wherein the magnetic nanoparticles are Fe₃O₄ nanoparticles having an average size of approximately 8 nm.

4. The superparamagnetic low-loss polymer nanocomposite of claim 1, wherein the magnetic nanoparticles are CoFe₂O₄ nanoparticles.

5. The superparamagnetic low-loss polymer nanocomposite of claim 4, wherein the magnetic nanoparticles are CoFe₂O₄ nanoparticles having an average size of approximately 10 nm.

6. The superparamagnetic low-loss polymer nanocomposite of claim 1, wherein the surfactant is oleylamine.

7. The superparamagnetic low-loss polymer nanocomposite of claim 1, wherein the surfactant is oleic acid.

8. The superparamagnetic low-loss polymer nanocomposite of claim 1, wherein the low-loss polymer is about 25% butadiene resin and copolymer dissolved in xylene.

9. A method for preparing a polymer nanocomposite, useful as a superparamagnetic low-loss material, comprising the steps of:
coating magnetic nanoparticles with surfactants;
dissolving a low-loss polymer and the coated magnetic nanoparticles in hexane; and
magnetically stirring the dissolved low-loss polymer and coated magnetic nanoparticles to obtain a polymer nanocomposite having substantially uniform dispersion.

10. The method of claim 9, wherein the magnetic nanoparticles are Fe₃O₄ nanoparticles.

11. The method of claim 10, wherein the magnetic nanoparticles are Fe₃O₄ nanoparticles having an average size of approximately 8 nm.

12. The method of claim 9, wherein the magnetic nanoparticles are CoFe₂O₄ nanoparticles.

13. The method of claim 12, wherein the magnetic nanoparticles are CoFe₂O₄ nanoparticles having an average size of approximately 10 nm.

14. The method of claim 9, wherein the surfactant is oleylamine.

15. The method of claim 9, wherein the surfactant is oleic acid.

16. The method of claim 9, wherein the low-loss polymer is about 25% butadiene resin and copolymer dissolved in xylene.

17. The method of claim 9, wherein the magnetic nanoparticles comprises a plurality of individual magnetic nanoparticles and wherein coating the magnetic nanoparticles with surfactants further comprises substantially completely encapsulating and isolating each of the individual magnetic nanoparticles.

18. A superparamagnetic low-loss polymer nanocomposite material produced according to the process of claim 9.

19. The superparamagnetic low-loss polymer nanocomposite material of claim 18, wherein the magnetic nanoparticles are Fe₃O₄ nanoparticles.

20. The superparamagnetic low-loss polymer nanocomposite material of claim 18, wherein the magnetic nanoparticles are CoFe₂O₄ nanoparticles.
